(19) United States
(12) Patent Application Publication
(10) Pub. No.: US 2024/0260637 A1
(43) Pub. Date: Aug. 8, 2024

(54) OIL IN WATER EMULSIFIED FOOD COMPOSITION COMPRISING AQUAFABA AND PROCESS FOR MANUFACTURING THE SAME

(71) Applicant: Conopco, Inc, d/b/a UNILEVER, Englewood Cliffs, NY (US)

(72) Inventors: Ryan Michael Clifford, Utrecht (NL); Hyunjung KIM, Arnhem (NL)

(73) Assignee: Conopco, Inc, d/b/a UNILEVER, Englewood Cliffs, NJ (US)

(21) Appl. No.: 18/567,868

(22) PCT Filed: May 12, 2022
(86) PCT No.: PCT/EP2022/062991

§ 371 Date: Dec. 7, 2023

(30) Foreign Application Priority Data
Jun. 18, 2021 (EP) 21180430.7

(51) Int. Cl. A23L 35/00; A23L 27/60; A23L 29/10; A23L 29/212

(52) U.S. Cl. CPC A23L 35/10; A23L 27/60; A23L 29/10; A23L 29/212

(57) ABSTRACT

The present invention relates to an oil in water emulsified food composition comprising from 5 to 65 wt % of vegetable oil, starch and aquafaba.

The present invention relates to a process to prepare an oil-in-water emulsified food composition comprising from 5 to 65 wt % of vegetable oil. The invention further relates to an oil-in-water emulsified food composition comprising from 5 to 65 wt % of vegetable oil and aquafaba.

### BACKGROUND

Oil-in-water emulsified food compositions such as mayonnaise, mayonnaise-like dressings and salad dressings rely on the presence of an emulsifier to stably distribute the vegetable oil droplets in a continuous water phase. In this manner a stable emulsion results, meaning that the oil drops do not coalesce and phase-separate from the water phase. The most common emulsifier used for this purpose is egg yolk, or a mixture of egg yolk and egg white. Dressing compositions wherein egg derived ingredients, or even all animal-derived ingredients are absent are increasingly desired by consumers. In this respect, several plant-based emulsifiers are known and described to be used in oil-in-water emulsified food compositions. An example of such plant-derived emulsifiers is plant protein, such as pea protein, soy protein or lentil protein. Another ingredient that is used as egg-ingredient replacer is aquafaba. Aquafaba is the liquid that remains after cooking of legume seeds (Fabaceae). In particular, aquafaba derived from chickpeas is known to be used as emulsifier to stabilize mayonnaise-like emulsions.

The viscosity of traditional oil-in-water emulsified food compositions is related to the oil level. Higher oil levels, such as for example 78 wt % as often used in mayonnaise, result in a high viscosity, recognizable as a semi-solid product, which is not pourable. The relatively high viscosity is manifested by the dense packing of small oil droplets, leaving little space for the droplets to move within the continuous water phase. A reduction in oil level leads to an emulsion wherein the oil droplets can move freely through the water phase, which reduces the viscosity of the product, and even further reduction of oil results in the product becoming liquid. For this reason, in low-oil mayonnaise-like products, having an oil level of for example from 5 to 65 wt %, a thickener is added to stabilize the water phase. A known thickener is starch. When using a thickener like starch, the continuous water phase becomes solidified like a gel, wherein the oil droplets are ‘fixed’. In this manner a low-oil mayonnaise can be manufactured with the viscosity resembling that of high-oil mayonnaise.

Despite the well-appreciated emulsifying properties of aquafaba in mayonnaise-like compositions with a normal oil level, e.g. 78 wt %, unfortunately it was found that when aquafaba is used as the egg-replacer in mayonnaise-like food compositions, using a relatively low oil level, such as from 5 to 65 wt % and starch as a thickener of the continuous water phase, such emulsions could not be prepared, at least not that successfully and satisfying as at a high oil level. The production process of consumer-grade, microbiologically safe food products, as used in a commercial factory ran into several complications. This is why, to the best knowledge of the inventors, water-in-oil emulsified food compositions with a relatively low oil level and starch, using aquafaba as egg-replacer do not exist.

Industrial production of low-oil mayonnaise comprises several production steps. Basically, three ingredient phases are mixed: an emulsifier phase, an oil phase and a starch phase. In the situation wherein aquafaba is used, the emulsifier phase contains the aquafaba. The oil phase comprises the vegetable oil. The starch phase comprises typically ingredients such as water, starch, acids like vinegar, salt etc. The pH of the starch phase is low, due to the presence of the acidulant, to allow the batches of the starch phase to remain microbiologically stable during a typical factory setting, i.e. before and during the production process, and storage of up to several days is not uncommon.

To activate the starch phase, all its ingredients are added to the water and the mixture is typically heated to a relatively high temperature, above the gelatinization temperature of the starch that is used, and then cooled back to room temperature. The starch phase is mixed with the emulsifier phase and the oil phase to provide an emulsion.

It now appeared, that in the case aquafaba was used as the emulsifying phase in mid- to low oil emulsions, the resulting emulsion product, such as a dressing or mayonnaise product, has a thin structure. Without willing to be bound by theory, the inventors believe that the use of aquafaba as emulsifier phase results in a too high viscosity of the starch phase, thereby limiting its functionality. It appeared that adding the aquafaba, which is the emulsifying phase, to the starch phase before cooking of the starch phase, in an attempt to overcome the mentioned issue, damaged the emulsifying properties of aquafaba, due to the low pH in the starch phase. Post dosing of vinegar, rather than adding the vinegar to the starch phase, in an attempt to overcome this, appeared not to be an option in an industrial setting, as it would include the risk for microbiological contamination of earlier prepared starch phases. An addition of the starch phase in this manner further appeared to create the problem that the total gelling, thickening, and water binding capacity of the starch is reduced by the process conditions during the high-impact emulsification milling with the oil phase. Alternatively, post-dosing a significant amount of the aquafaba after a pre-emulsion is made with the acid starch phase, the oil and part of the aquafaba, in an attempt to benefit from the emulsifying capacity of the post-dosed part of the aquafaba, does not work, as the emulsion is already made, the oil droplets are already dispersed, and the post-dosed aquafaba does not contribute anymore to the emulsion, and is in fact wasted.

WO2020/193641 relates to plant protein isolates, in particular to bean protein isolates. It discloses a 25% fat mayonnaise composition that contains dry aquafaba, starch and xanthan gum.

### SUMMARY OF THE INVENTION

Accordingly, the need remained for an industrial production process to prepare an oil-in-water emulsified food composition comprising from 5 to 65 wt % of vegetable oil and starch and aquafaba-emulsifier. The need further remained for an oil-in-water emulsified food product comprising 5 to 65 wt % of vegetable oil, starch and aquafaba-emulsifier.

Surprisingly, the above-mentioned complications could be overcome, at least in part, by the following process and product, wherein the product and process use aquafaba in dry form, like a powder, and wherein in the process the thickening starch is added at different stages, before emulsification and after it. These applications made it possible to prepare aquafaba-stabilised low- to mid oil oil-in-water emulsions of the mayonnaise type that allowed texturizing with starch.

Accordingly, in a first aspect, the present invention relates to a process to manufacture an oil-in-water emulsified food composition, the process comprising the steps of:
a) Providing a starch phase, comprising water, an acidulant and starch,
b) Heating the starch phase of step a) to a temperature above the gelatinization temperature of the starch, in case the starch is cook-up starch,
c) Providing an emulsifier phase, comprising the step of mixing water and dry aquafaba, wherein dry aquafaba is added in an amount of from 0.02 to 4 wt %, preferably of from 0.1 to 1 wt %, calculated as weight of its legume protein content, based on the weight of the resulting food composition,
d) Combining part of the starch phase resulting from step b) with emulsifier phase resulting from step c), and mix,
e) Combining the mixture resulting from step d) with 5 to 65 wt % of vegetable oil, based on the weight of the resulting food composition, and homogenising to result in an oil-in-water emulsion with an average oil droplet size D3,3 of below 50 micron,
f) Combining the mixture resulting from step e) with the part of the starch phase resulting from step b) that was not added at step d),
   to result in an oil-in-water-emulsified food composition with a pH of between 2.5 and 5.5.

In a further aspect, the invention relates to an oil-in-water emulsified food composition, comprising:
from 5 to 65 wt %, preferably of from 10 to 65, even more preferably of from 25 to 65 wt % of vegetable oil, even more preferably of from 30 to 65 wt %, even more preferably of from 30 to 60 wt %, even more preferably of from 30 to 55 wt % of vegetable oil.
from 0.5 to 12 wt % of total starch, from 0.02 to 4 wt % of aquafaba calculated as legume protein, preferably in an amount of from 0.1 to 1 wt %, calculated as weight of its legume protein, based on the weight of the food composition,
   wherein the composition has a pH of between 2.5 and 5.5.

In a further aspect, the invention relates to the use in an oil-in-water emulsified food composition of dry aquafaba in an amount of from 0.02 to 4 wt %, preferably of from 0.1 to 1 wt %, calculated as weight of its legume protein, based on the weight of the food composition, to provide an oil-in-water emulsified food composition comprising:
from 5 to 65 wt %, preferably of from 10 to 65, even more preferably of from 25 to 65 wt % of vegetable oil, even more preferably of from 30 to 65 wt %, even more preferably of from 30 to 60 wt %, even more preferably of from 30 to 55 wt %.
From 1 to 12 wt % of total starch, based on the weight of the composition,
   wherein the composition has a pH of between 2.5 and 5.5.

### DETAILED DESCRIPTION OF THE INVENTION

All percentages, unless otherwise stated, refer to the percentage by weight (wt %). “Weight ratio” means that the concentration (wt %) of a first (class of) compound(s) is divided by the concentration (wt %) of a second (class of) compound(s) and multiplied by 100 in order to arrive at a percentage.

“Spoonable” means that a composition is semi-solid but not free-flowing on a time scale typical for eating a meal, meaning not free-flowing within a period of an hour. A sample of such substance can be dipped with a spoon from a container containing the composition. Except in the operating and comparative examples, or where otherwise explicitly indicated, all numbers in this description indicating amounts or ratios of material or conditions of reaction, physical properties of materials and/or use are to be understood as modified by the word “about”.

Features described in the context of one aspect of the invention can be applied in another aspect of the invention.

In a first aspect, the invention relates to a new process to prepare an oil-in-water emulsified food composition.

### Emulsion

The process of the first aspect of the invention results in an emulsified food composition and the composition of the second aspect of the invention is in the form of an oil-in-water emulsion. Examples of oil-in-water emulsions encompassed by the present invention include emulsified sauces, such as mayonnaise, mayonnaise-like emulsions and salad dressings. Preferably, the food composition is a mayonnaise, a mayonnaise-like product, such as a low-oil mayonnaise or egg-less mayonnaise, or a salad dressing, and most preferably a mayonnaise or mayonnaise-like product.

Mayonnaise is generally known as a thick, creamy sauce that can be used as a condiment with other foods. Mayonnaise is a stable water-continuous emulsion of typically vegetable oil, egg yolk and either vinegar or lemon juice. In many countries the term mayonnaise may only be used in case the emulsion conforms to the “standard of identity”, which defines the composition of a mayonnaise. For example, the standard of identity may define a minimum oil level, and a minimum egg yolk amount. Also, mayonnaise-like products having e.g. oil levels lower than defined in a standard of identity or not containing egg yolk are in the scope of the present invention. In the art, this kind of products may contain thickeners like starch to stabilise the aqueous phase. Mayonnaises and mayonnaise-like products may vary in colour, and are generally white, cream-coloured, or pale yellow. The texture may range from light creamy to thick. Generally, mayonnaise and mayonnaise-like products are spoonable. Mayonnaises in the context of the present invention do not necessarily need to conform to a standard of identity in any country. Salad dressings are known in the art and may have a lower viscosity than mayonnaise or mayonnaise-like products and they may include e.g. emulsified products known in the market as ‘dips’ or ‘variety sauces’, etc.

In the first aspect of the invention, a process is provided to manufacture an oil in water emulsified food composition. The process comprises the steps of providing a starch phase, an emulsifier phase and mixing them together with vegetable oil.

### Step a

In a first step a) of the process, a starch phase is provided. The starch phase comprises water, acidulant and starch. The starch is a relevant ingredient to provide texture to the resulting food composition. The resulting food composition is a mid-oil or low-oil emulsion, as reflected in the oil content of between 5 and 65 wt %. This oil content is insufficient to provide the texture to the composition that the consumer recognizes as the texture of a high oil (e.g. 78%) dressing, such as for example a mayonnaise or a mayonnaise-like dressing.

The amount of starch added in step a) to provide the starch phase is preferably from 0.1 to 10 wt %, more preferably of from 1 to 8 wt %, and even more preferably of from 2 to 6 wt %, based on the weight of the resulting food composition.

The starch in step a) is preferably added in an amount of below 12.5 wt %, preferably of 12.5 to 3 wt %, even more preferably of from 11.5 to 4 wt %, based on the weight of the starch phase.

The ratio of starch to total water in the starch phase is preferably below 1:7, preferably between 1:7 to 1:29, more preferably from 1:8 to 1:24 and even more preferably of from 1:8.5 to 1:24. The ratio is relevant to allow the starch to swell properly during heating step b) and provide the thickening effect.

The total starch phase, added in step d) and f), is preferably 30 to 94 wt %, and more preferably 34 to 90 wt %, even more preferably, from 40 to 60 wt % of the resulting food composition. The weight ratio of starch phase to emulsifier phase is preferably from 94:0.1 to 30:12, preferably from 94:0.5 to 30:10.

The starch used to prepare the starch phase in the present invention is preferably selected from the group consisting of corn starch, potato starch, tapioca starch, rice starch and mixtures thereof. It may be preferred that the starch is waxy starch, in some cased it can be preferred that the starch is not waxy starch.

The starch is either non-modified starch or modified starch. It may be preferred that the starch is physically modified starch. More preferred, the starch is native starch. Preferably the starch is not chemically modified. The starch is a starch that needs to be cooked-up. This means, it has to be heated above its gelatinization temperature, to activate the thickening capacity. By heating the starch, e.g. the amylose is released from the starch granules, and can form a starch matrix in the water phase.

The starch phase comprises preferably water in a total amount of from 80 to 99.9 wt %, preferably from 85 to 98 wt %, based on the weight of the starch phase.

Water as ingredient, i.e. not as ingredient of another ingredient like vinegar, is preferably added in the starch phase in an amount of from 79.5 to 99.4 wt %, preferably of from 84.5 to 97.5 wt %. Water is preferably added, as individual ingredient in the starch phase, in an amount of from 30 to 94 wt %, more preferably from 34 to 90 wt %, even more preferably from 35 to 70 wt %, even more preferably of from 35 to 55 wt %, based on the weight of the resulting food composition.

In the context of industrial dressing manufacturing, the different phases are produced in different batches and used in the appropriate amount when needed. This requires the need to store the phases, such as the starch phase, for hours or days, with the risk for microbiological spoilage. To allow such factory processing, the starch phase is acidified, which is typically done with acidulant. Acidulant is preferably added in an amount to provide a pH of between 2.5 and 5.5 in the resulting food composition. In case the acidulant is vinegar, the vinegar is preferably added in an amount of from 0.5 to 10 wt %, preferably 1 to 5 wt %, based on the weight of the resulting food composition. The amount is calculated based on HAc level of 12 wt % in the vinegar. It is within the skill of the artisan to recalculate the equivalent amounts for vinegars with a different HAc level.

### Step b

To provide the desired thickening activity, the starch has to become activated. The starch, mixed with water, is heated above the gelatinization temperature of the starch, as known to the artisan. This is especially the situation when the starch is cook-up starch. This is starch that is not pre-gelatinized and needs to be activated in the water by heating, as known in the art. The starch phase is preferably heated to a temperature of between 55 and 95° C., preferably between 58 and 95° C. Pregelatinized starch is less preferred, because it is more expensive. It is prepared by heating the starch and drying it. Pregelatinized starch could be preferred to be absent. In case pregelatinized starch is used in step b), it may be preferred that the pre-gelatinized starch is dissolved in the starch phase, i.e. in the aqueous part thereof. Such a pregelatinized starch typically is cold-water soluble and thickens without heating the starch phase. Heating may still be applied if considered useful.

### Step c

In step c of the process of the invention, an emulsifier phase is provided. An emulsifier is required in the invention, to emulsify the oil droplets in the continuous water phase of the resulting food composition and prevent them from coalescing into an oil layer. Traditionally, the emulsifier in mayonnaise is egg or egg yolk. Increasingly, consumers prefer to dressing compositions such as mayonnaise or mayonnaise like products that are free from animal derived products. The oil-in-water-emulsified products therefore preferably are free from egg-derived emulsifier, preferably are free from animal derived ingredients. It is preferred that the food composition is free from egg yolk or dairy protein, even more preferably is free from egg yolk.

Plant-based oil-in-water emulsions have been described. In such compositions a plant protein is responsible for the emulsifying activity. One problem that is associated with several plant proteins when used as emulsifier is that they provide a powdery, rough mouthfeel to the resulting emulsion. Other plant proteins provide textural complications, sometimes resembling cottage cheese, especially at higher oil levels. It is therefore desired to provide an oil-in-water emulsion that has a smooth, non-rough mouthfeel. In the present invention, aquafaba is the emulsifier. Preferably the composition is free from non-mustard plant protein that does not originate from the aquafaba.

Aquafaba is known for its emulsifying effect in mayonnaise-like compositions. Complications arise, when a low oil or mid oil dressing is prepared, wherein the continuous water phase needs to be structured with starch. Optimal thickening capacity of the starch appeared however to be incompatible with the use of aquafaba as emulsifier, without compromising the microbiological stability and the thickening capacity of the starch.

It has now been discovered by the present inventors that a low- to mid-oil oil in water emulsion, thickened with starch to obtain a viscosity similar to full-fat mayonnaise, could be prepared by a process, wherein an emulsifying phase is used comprising aquafaba in powder form (dry aquafaba) and if the starch phase is added using a double-dosing regime during the production process. To the best knowledge of the inventors, despite the rising popularity of aquafaba as an emulsifier in mayonnaise, a low- to mid-oil oil-in-water emulsion emulsified with aquafaba and resembling the viscosity and stability of egg-emulsified emulsions does not exist and could not be made up to now.

Accordingly, in step c) of the process of the invention, an emulsifier phase is provided, comprising the step of mixing aquafaba in dry form with water. It could be preferred in some applications that the resulting emulsifier phase could be pasteurised. The dry aquafaba is typically aquafaba in powder form. Dry aquafaba may typically have a water level of below 20 wt % (e.g. of from 0.1 to 20 wt %), preferably below 12 wt % (e.g. of from 0.1 to 12 wt %), more preferably below 6 wt % (e.g. of from 0.1 to 6 wt %) and more preferably below 4 wt % (e.g. of from 0.1 to 4 wt %), based on the weight of the dry aquafaba (the aquafaba powder). Preferably from 10 to 70 wt % of dry aquafaba, more preferably from 20 to 50 wt % is added into the emulsifier phase, based on the weight of the emulsifier phase.

The emulsifier phase comprises accordingly preferably from 1.5 to 17.5 wt %, preferably of from 2.2 to 17.5 wt %, more preferably of from 2.5 to 12.5 wt %, even more preferably of from 3 to 12.5 wt %, even more preferably of from 2.5 to 7 wt %, even more preferably of from 3 to 7 wt %, aquafaba (calculated as the weight of its legume protein content, on weight of emulsifier phase).

Preferably, the dry aquafaba is added in the emulsifier phase in an amount of 0.08 to 26.7 wt %, preferably of from 0.4 to 6.7 wt % based on the weight of the resulting food composition.

Preferably, the dry aquafaba is added in the emulsifier phase in an amount of from 0.02 to 4 wt %, preferably of from 0.1 to 1 wt %, calculated as its legume protein content, based on the weight of the resulting food composition. The skilled person will understand the higher levels in the range are typically applied when higher oil levels are used and vice versa.

The emulsifier phase that is combined with at least the oil and the starch phase is preferably of from 0.1 to 12 wt %, preferably of from 0.5 to 10 wt %, based on the weight of the resulting food composition.

The dry aquafaba that is used in the present invention is preferably pulse seed aquafaba in dry form. It is preferably selected from the group consisting of dry chickpea aquafaba, dry white bean aquafaba, dry pea aquafaba, dry lentil aquafaba, dry soybean aquafaba, dry kidney bean aquafaba, dry black bean aquafaba and mixtures thereof. More preferably, the aquafaba powder is dry chickpea aquafaba or dry white bean aquafaba. Most preferably, the aquafaba powder is dry chickpea aquafaba.

The dry aquafaba typically comprises protein in an amount of from 15 to 25 wt %. Preferably of from 18 to 24 wt %. Preferably more than 90 wt %, even more preferably more than 95 wt %, even more preferably all protein in the food composition originates from the aquafaba. It is preferred that more than 90 wt %, even more preferably more than 95 wt %, even more preferably more than 99 wt %, and even more preferably all non-mustard protein in the food composition is protein from legumes, preferably is selected from the group consisting of chickpea protein, white bean protein, lentil protein, soya bean protein, black bean protein, and mixtures therefore, more preferably from chickpea protein or white bean protein, most preferably chickpea protein.

Aquafaba powder can suitably be produced by a person skilled in the art. The legumes are heated at a temperature of from 60 to 160° C., preferably boiled, e.g. for a period of from 2 minutes to 20 hours, and separated from the cooking liquid. It can be preferred that the legumes are heated in water at 70 to 160° C. for 15 minutes to 20 hours, preferably at 80 to 130° C. for 30 minutes to 10 hours, preferably from 30 minutes to 5 hours. The skilled person will understand that lower temperatures require a higher time period and vice versa. The resulting liquid is then concentrated and then dried. This can be done for example by air drying or spray drying, as known in the art. The process of the invention may comprise the step of preparing the aquafaba in dry form, wherein this step comprises heating legumes in water, preferably chickpea or white beans, separating them from the cooking liquid, and drying the liquid to obtain dry aquafaba. Aquafaba in dry form can easily be supplied from commercial manufacturers like for example Döhler (Germany) or VOR (USA) as known to the artisan.

### Step d

In step d), at least part of the starch phase resulting from step b) is combined with the emulsifier mix resulting from step c). The starch phase is combined in an amount of from 10 to 70 wt %, preferably of from 20 to 50 wt %, based on the total amount of starch phase added in the resulting food composition. The amount of the starch phase added in step d) is preferably from 10 to 70 wt %, preferably of from 20 to 50 wt % based on the weight of the resulting food composition. Mixing time takes preferably of between 5 seconds and 5 minutes, preferably from 10 seconds to 2 minutes for optimal emulsifying effect.

### Step e

In step e), the mix resulting from step d) is combined with vegetable oil. Preferably the total vegetable oil is liquid preferably at 20° C., more preferably at 5° C. Preferably, vegetable oil comprises, preferably consists of vegetable oils which are liquid preferably at 20° C., more preferably at 5° C. Preferably the oil comprises an oil selected from the group consisting of sunflower oil, rapeseed oil, olive oil, soybean oil, and combinations of these oils. More preferably, the oil is an oil selected from the group consisting of sunflower oil, rapeseed oil, olive oil, soybean oil, and combinations of these oils. Most preferred, the oil is soybean oil or rapeseed oil. The amount of vegetable oil used in the present invention is from 5 to 65 wt %, preferably of from 10 to 55 wt %, even more preferably of from 20 to 50 wt %, based on the weight of the resulting food composition.

The resulting combination is homogenized. Homogenization is conveniently carried out with an apparatus conventional in the art of industrial dressing preparation that allows for high shear homogenizing, such as for example a rotor-stator mixing device or a colloid mill. Homogenisation is preferably comprising high shear. It is preferably carried out to the extent to achieve an oil droplet size D3.3 which is below 50 micron, preferably below 10 micron, preferably from 0.2 to 10 micrometers, more preferably of between 1 and 8 micrometers, as known in the art, see M. Alderliesten, Particle & Particle Systems Characterization 8 (1991) 237-241; for definitions of average diameters. This oil droplet size reflects the size as obtained by industrial mayonnaise production.

### Step f

The mixture resulting from step e) is combined with the part of the starch phase that was not added at step d). The size of the starch phase added in step f) may preferably be from 30 to 90 wt %, preferably from 50 to 80 wt %, based on the total amount of starch phase.

It is preferred that 18 to 90 wt %, preferably 38 to 80 wt % of the total starch is added in step f), based on the weight of the total starch present in the resulting food composition.

Preferably, the part of the starch phase is added in an amount of 9 to 84.6 wt %, preferably 15 to 75.5 wt % based on the weight of the resulting food composition. The part of the total starch phase added in step f) is typically mixed in relatively gently in the mixture resulting from step e). This is conveniently done by homogenizing without high shear as the skilled person understands, by using for example a vessel with paddle mixer, or similar standard equipment. This allows for the starch to optimally maintain its thickening capacity.

The invention further relates to a product obtainable by, preferably obtained by the process of the invention.

### Product

In a second aspect, the present invention relates to an oil-in-water emulsified food composition comprising
from 5 to 65 wt %, preferably of from 10 to 60 wt %, preferably from 15 to 55 wt %, even more preferably of from 20 to 50 wt % of vegetable oil,
from 0.1 to 12 wt % of total starch, based on the weight of the food composition,
from 0.02 to 4 wt % of aquafaba, preferably in an amount of from 0.1 to 1 wt %, calculated as the weight of its legume protein, based on the weight of the food composition,
   wherein the composition has a pH of between 2.5 and 5.5.

The composition of the present invention is a mid to low-oil oil-in-water emulsion based on aquafaba. The composition comprises from 5 to 65 wt %, preferably of from 10 to 65, even more preferably of from 25 to 65 wt % of vegetable oil, even more preferably of from 30 to 65 wt %, even more preferably of from 30 to 60 wt %, even more preferably of from 30 to 55 wt % of vegetable oil based on the weight of the composition.

The total water content of the composition is preferably from 34.8 to 94.8 wt %, preferably of from 44.8 to 89.8 wt %, based on the weight of the composition.

The composition comprises aquafaba. The aquafaba is preferably present in an amount of 0.02 to 4 wt %, preferably 0.1 to 1 wt % (calculated based on the weight of its legume protein on weight of the composition). The aquafaba is preferably present in an amount of from 0.08 to 26.7 wt %, preferably of from 0.4 to 6.7 wt % (dry weight aquafaba on weight of the food composition), which is the amount of aquafaba powder used in the composition. Accordingly, legume protein is preferably present in an amount of from 0.02 to 4 wt %, preferably from 0.1 to 1 wt % based on the weight of the food composition. The composition typically comprises legume protein-polysaccharide conjugates.

The aquafaba is preferably present in an amount of from 0.03 to 80 wt %, preferably of from 0.15 to 20 wt %, as calculated as weight of legume protein in the aquafaba to weight of oil in the composition. The ratio of dry aquafaba to starch not originating from aquafaba is preferably of from 26.7:0.1 to 0.08:10, preferably of from 6.7:0.1 to 0.4:10.

The composition of the invention comprises starch as a thickening agent. Starch is present in a total amount of from 0.1 to 12 wt %, more preferably of from 0.5 to 10 wt %, even more preferably of from 0.5 to 8 wt % based on the weight of the composition. The amount of starch not-originating from aquafaba, preferably starch not originating from chickpea, more preferably not originating from chickpea or white bean, preferably not originating from legume, is preferably of from 0.1 to 10 wt %, preferably of from 1 to 8 wt %. Such starch is preferably selected from the group consisting of potato starch, corn starch, tapioca starch, rice starch and mixtures thereof. Legume starch, preferably chickpea starch or white bean starch may be present in an amount of from 0.01 to 11.9 wt %, preferably of from 0.065 to 10 wt %, based on the weight of the composition.

The dual addition regime of starch phase of the present invention, i.e.in steps d) and f) of the process of the invention, enables that no additional thickener other than starch needs to be present anymore. Accordingly, the amount of gums is preferably below 0.1 wt %, preferably the composition is free from gums. It is preferably free from xanthan gum or guar gum, most preferably free from xanthan gum. Starch is preferably the only hydrocolloid thickener, preferably the only thickener in of the continuous water phase. Mustard is not considered a thickener in this context.

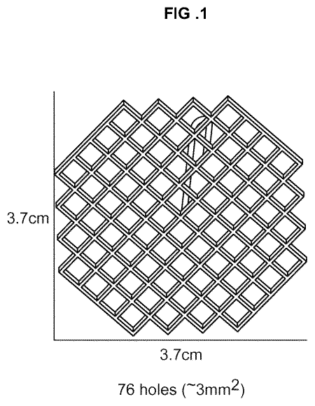

A hardness, of the composition (as expressed in Stevens value, in grams) could be reached that resembled the hardness of a full-fat (78 wt % oil) mayonnaise composition, and appeared to stay stable upon storage of at least a month, preferably at least 2, 4 or even 6 months, e.g. 1 to 24 months, preferably 2 to 12 months, more preferably 2 to 8 months. The Stevens Value (in grams) is preferably of between 50 g and 400 g, preferably between 80 g and 300 g, as measured at 20° C. The Stevens value (in grams) is preferably in the same order of magnitude as observed for an equivalent composition with a high oil level (e.g. 75 wt % or even 80 wt %). The Stevens value is measured as known in the art, using an apparatus as depicted in FIG. 1.

The viscosity of the food composition of the invention preferably may range between 500 and 30,000 mPa·s, preferably 2,000 to 30,000 mPa·s, and most preferably 5,000 to 20,000 mPa·s. Especially when the composition is a mayonnaise-like composition, e.g. en aiming to resemble viscosity of a mayonnaise composition with 75 wt % or even 80 wt % of oil, the viscosity of the present composition typically lies in the range of 2,000-30,000 mPa·s, more preferably in the range of 5,000-20,000 mPa·s. The viscosity can be determined using a Brookfield viscometer operated at 50 rpm and 20° C., using spindle size #7 (according to IS02555).

pH

The composition of the second aspect of the invention and the composition resulting from the process of the invention, has preferably a pH ranging from 2.5 to 5.5, preferably from 2.5 to 4.8, preferably from 3 to 4.6.

The total amount of acid in the composition can be determined by titration with sodium hydroxide (NaOH), and expressed as titratable acidity. This is called the titratable acidity, expressed as acetic acid (HAc), which is determined using the following formula.

$$\\ \begin{matrix}HAc \% = 100 \% \cdot ( V \cdot t \cdot M ) / m & ( 1 )\end{matrix}$$

wherein:
V: volume NaOH solution added (mL)
t: concentration NaOH solution (mol/L)
M: molecular weight HAc (60.052 g/mol)
m: mass (g) product which has been titrated

The composition preferably comprises an acidulant. Preferably the composition comprises organic acid. More preferably, the acid is organic acid. Preferably, the composition comprises an acidulant selected from the group consisting of acetic acid, citric acid, and mixtures thereof.

Preferably the composition of the invention has a total titratable acidity ranging from 0.03% to 3% by weight expressed as acetic acid, preferably from 0.05% to 2% by weight, preferably from 0.1% to 1% by weight. Most preferably the composition comprises acetic acid. Acetic acid is preferably present in an amount of more than 50 wt %, more preferably more than 80 wt %, even more preferably more than 90 wt %, even more preferably more than 95 wt % based on the weight of the total amount of acid in the composition.

The acids as described in this specification include their corresponding salts which are in equilibrium with the acids (acetates, citrates). In case a concentration of an acid is provided, then this concentration refers to total concentration of the acid and its corresponding salt.

Acidulant is preferably added during preparation of the food composition in the form of vinegar Acidulant is preferably added in an amount to achieve a preferred pH of the resulting food composition of from 2.5 to 5.5, preferably from 2.5 to 4.8, preferably 3 to 4.6. The composition preferably comprises vinegar.

### Other Ingredients

The composition may suitably contain one or more additional ingredients which are common to mayonnaise-type emulsions. Examples of such optional ingredients include salt, spices, sugars, and herbs. Such optional additives, when used, collectively do not make up more than 40 wt %, more preferably not more than 20 wt % of the emulsified food product.

The composition of the invention may comprise sugar, but high levels are not desired. Sugar may be present to an amount of from 0.1 to 15 wt %, preferably of from 0.3 to 6 wt %, even more preferably of from 0.4 to 5 wt %, most preferably of from 0.5 to 4 wt %, based on the weight of the composition.

Total alkaline metal salt, for example sodium chloride, may be present to an extent of from 0.1 to 5 wt %, preferably from 0.15 to 4 wt %, or more preferably of from 0.2 to 3 wt %, based on the weight of the composition.

It may be preferred that sugar, salt or both are present in the composition. If used, sugar and salts are preferably added in the starch phase, during step a) of the process of the invention. Plant material in the form of herbs and spices may be preferably added during step a), or f) of the process. It may be preferred, that it is added at step f). The composition may comprise for example mustard.

It could be preferred, that the composition of the invention is an oil-in-water emulsified food composition, comprising:
from 30 to 60 wt % of vegetable oil,
from 0.5 to 7 wt % of total starch, preferably corn starch
from 0.1 to 1 wt % of aquafaba, calculated as the weight of its legume protein, based on the weight of the food composition,
   wherein the weight ratio of aquafaba, calculated as its legume protein, to total oil is of from 0.15 to 20, wherein the aquafaba is chickpea or white bean aquafaba.
   wherein the total starch to total water ration is of from 3 to 12.5 wt %,
   wherein the composition has a pH of between 2.5 and 5.5,
   wherein the composition has a hardness expressed as Stevens vale of between 50 and 400, calculated at 20° C. and using a Stevens LFRA Texture Analyser (ex Brookfield Viscometers Ltd., UK) with a maximum load/measuring range of 1000 grams, and applying a penetration test of 25 mm.

### Use

In a further aspect the invention relates to the use in an oil-in-water emulsified food composition of aquafaba in the form of a powder (dry aquafaba) in an amount of from 0.01 to 4 wt, preferably in an amount of from 0.1 to 1 wt %, calculated as the weight of its legume protein based on the weight of the composition, to provide an oil-in-water emulsified food composition. The food composition comprises from 5 to 65 wt % of vegetable oil, and from 0.1 to 12 wt % of total starch, based on the weight of the composition. As set out above, it is with the use of the aquafaba in dry form, that low to mid oil water-in-oil emulsions could be made that show proper emulsification in the product, i.e. no oil coalescing and separation from the water phase, and allow the amount of starch to be activated to provide a viscosity that resembles that of a full fat mayonnaise composition. The Stevens Value (in grams) is preferably of between 50 g and 400 g. The viscosity may range between 500 and 30,000 mPa·s, as indicated above. The composition has a pH of between 2.5 and 5.5.

### Methods

### Methods—Texture Measurements

Thickness—Stevens value: the Stevens value is determined at 20° C. by using a Stevens LFRA Texture Analyser (ex Brookfield Viscometers Ltd., UK) with a maximum load/measuring range of 1000 grams, and applying a penetration test of 25 mm using a grid, at 2 mm per second penetration rate, in a cup having a diameter of 65 mm, that contains the emulsion; wherein the grid comprises square openings of approximately 3×3 mm, is made up of wire with a thickness of approximately 1 mm, and has a diameter of 40 mm. One end of a shaft is connected to the probe of the texture analyser, while the other end is connected to the middle of the grid. The grid is positioned on the flat upper surface of the emulsion in the cup. Upon starting the penetration test, the grid is slowly pushed downward into the emulsion by the texture analyser. The final force exerted on the probe is recorded, giving the Stevens value in gram. A drawing of the grid is given in FIG. 1. The grid is made from stainless steel, and has 76 holes, each hole having a surface area of approximately 3×3 mm.

Viscosity—The viscosity can be determined by using a Brookfield viscometer (ex Brookfield Viscometers Ltd., UK) operated at 50 rpm and 20° C., using the appropriate spindle for the expected viscosity (according to ISO2555), in this case spindle #7. The spindle, connected to the viscometer probe, is lowered into the emulsion until the indentation on the spindle is reached. The resistance measured during the spinning of the spindle in the emulsion, is the viscosity in milli Pascal per second (mPa*s).

The invention will now be illustrated by the following non-limiting examples.

### EXAMPLES

Two comparative compositions A and B where designed, wherein liquid aquafaba is used as emulsifier. The compositions had oil levels of 40 wt % and 50 wt %. The compositions could not be prepared or showed serious disadvantages during the production process and/or in the resulting product. Equivalent compositions C and D, according to the invention, where prepared, which are efficient to prepare in an industrial manufacturing setting and showed product quality and characteristics resembling those of full fat (78 wt % oil) mayonnaise.

### Ingredients

Three phases where prepared: a starch phase, an emulsifier phase and an oil phase. Aquafaba originated from chickpea and was added in an amount of 1 wt % aquafaba protein on oil. Liquid aquafaba was supplied from Sesajal (Mexico), dry aquafaba from Döhler (Germany). The pH of the resulting emulsified food compositions was <4.6.

| | Comp. Ex. A | Comp. Ex. B | Ex. C | Ex. D |
|---|---|---|---|---|
| | wt. % | wt. % | wt. % | wt. % |
| EMULSIFIER PHASE | | | | |
| Water | | | 5 | 5 |
| aquafaba dry (Döhler) | | | 1.87 | 2.34 |
| Liquid Aquafaba | 14.8 | 18.5 | | |
| TOTAL | 14.8 | 18.5 | 6.87 | 7.34 |
| OIL PHASE | | | | |
| Sunflower Oil | 39.8 | 49.8 | 39.8 | 49.8 |
| Flavour | 0.2 | 0.2 | 0.2 | 0.2 |
| TOTAL | 40 | 50 | 40 | 50 |
| STARCH PHASE | | | | |
| Water | 34.9 | 22.2 | 42.83 | 33.36 |
| Vinegar spirit 12% | 1.7 | 1.7 | 1.7 | 1.7 |
| Lemon juice concentrate | 0.2 | 0.2 | 0.2 | 0.2 |
| Salt + sugar | 4.1 | 4.1 | 4.1 | 4.1 |
| Starch (Novation Endura | 4.3 | 3.3 | 4.3 | 3.3 |
| 0100) | | | | |
| TOTAL | 45.2 | 31.5 | 53.13 | 42.66 |
| TOTAL | 100 | 100 | 100 | 100 |

### Method

The compositions were prepared according to the following process:

The starch phase was prepared by dissolving the ingredients in the water in a standard steam jacketed mixing device. The mixture is heated for 7.5 minutes to 90° C. and subsequently cooled to 25° C. Half of the starch phase was combined with the emulsifier phase, and mixed for 20 seconds, the oil was then slowly added into the same device to obtain a pre-emulsion. The resulting pre-emulsion was then pumped through a colloid mill at 8000 rpm to achieve an oil droplet size of <10 microns. The resulting emulsion was returned to the original mixing vessel prior to the addition of the second half of the starch phase.

### Results

Regarding comparative examples A and B, the compositions show complications in production. The resulting compositions could not be mixed well, and the starch granules have not reached its optimal thickening functionality. Applying liquid aquafaba in the starch phase resulted in compositions wherein the emulsions were broken, observed as a layer of oil on the surface, and a curdled-like appearance of the resulting product. Examples C and D show that with the process of the invention and the use of dry aquafaba mid-oil mayonnaise-like compositions are obtained that are stable in terms of emulsion (no broken emulsions or curdled-like appearance) and are efficient in production and microbiologically safe. The droplet size of the oil D3,3 was below 10 micron and the compositions resemble full fat mayonnaises in texture and appearance.

1. A process to manufacture an oil-in-water emulsified food composition, the process comprising the steps of:
a) Providing a starch phase, comprising water, an acidulant, and starch,
b) Heating the starch phase of step a) to a temperature above the gelatinization temperature of the starch in case the starch is cook-up starch,
c) Providing an emulsifier phase, comprising the step of mixing water and dry aquafaba, wherein dry aquafaba is added in an amount of from 0.02 to 4 wt %, calculated as weight of its legume protein content, based on the weight of the resulting food composition,
d) Combining part of the starch phase resulting from step b) with emulsifier phase resulting from step c), and mix,
e) Combining the mixture resulting from step d) with 5 to 65 wt % of vegetable oil, based on the weight of the resulting food composition, and homogenising to result in an oil-in-water emulsion with an average oil droplet size D3,3 of below 50 micron,
f) Combining the mixture resulting from step e) with the part of the starch phase resulting from step b) that was not added at step d), to result in an oil-in-water-emulsified food composition with a pH of between 2.5 and 5.5.

2. The process according to claim 1, wherein the starch is potato starch, corn starch, tapioca starch, rice starch and mixtures thereof.

3. The process according to claim 1, wherein the weight ratio of starch to total water in the starch phase in step a) is between 1:7 to 1:29.

4. The process according to claim 1, wherein the aquafaba is from a legume selected from the group consisting of chickpeas, white beans, peas, lentils, soybeans, kidney beans, black beans and mixtures thereof.

5. The process according to claim 4, wherein the aquafaba is from chickpeas or white beans or a mixture thereof.

6. The process according to claim 1, wherein in step c) dry aquafaba is added in the mixture with water in an amount of from 10 to 70 wt %, based on the weight of the emulsifier phase.

7. The process according to claim 1, wherein in step c) dry aquafaba is added in an amount of from 0.08 to 27 wt %, based on the weight of the resulting food composition.

8. The process according to claim 1, wherein in step c) dry aquafaba is added in an amount of from 0.03 to 80 wt %, calculated as the weight of its legume protein on the weight of the vegetable oil in the resulting food composition.

9. The process according to claim 1, wherein the starch is added in step a) in an amount of from 0.1 to 10 wt %, based on the weight of the resulting food composition.

10. The process according to claim 1, wherein the part of the starch phase is added in step d) in an amount of from 10 to 70 wt %, based on the weight of the total amount of starch phase.

11. The process according to claim 1, wherein the vegetable oil is added in step e) in an amount of from 10 to 65 wt %, based on the weight of the resulting food composition.

12. An Oil-in-water emulsified food composition, comprising:
from 10 to 65 wt %, of vegetable oil,
from 0.5 to 12 wt % of total starch,
from 0.02 to 4 wt % of aquafaba, calculated as weight of its legume protein, calculated as weight of its legume protein, based on the weight of the food composition,
wherein the composition has a pH of between 2.5 and 5.5,
wherein the composition is free from gums, and
wherein the composition has a hardness expressed as Stevens value (in grams) of between 50 and 400, calculated at 20° C. and using a Stevens LFRA Texture Analyser (ex Brookfield Viscometers Ltd., UK) with a maximum load/measuring range of 1000 grams, and applying a penetration test of 25 mm.

13. The Oil in water emulsified food composition according to claim 12, wherein the composition comprises from 0.1 to 10 wt %, of starch, selected from the group consisting of corn starch, potato starch, tapioca starch, rice starch and mixtures thereof.

14. The Oil in water emulsified food composition according to claim 12, wherein the composition comprises legume protein that is conjugated to polysaccharide.

15. (canceled)

16. The process according to claim 1, wherein in the emulsifier phase, the dry aquafaba is added in an amount of from 0.1 to 1 wt %, calculated as weight of its legume protein content, based on the weight of the resulting food composition.

17. The process according to claim 3, wherein the weight ratio of starch to total water in the starch phase in step a) is between 1:8 to 1:24.

18. The process according to claim 6, wherein in step c) dry aquafaba is added in the mixture with water in an amount of from 20 to 50 wt %, based on the weight of the emulsifier phase.

19. The process according to claim 7, wherein in step c) dry aquafaba is added in an amount of from 0.4 to 7 wt %, based on the weight of the resulting food composition.

20. The process according to claim 8, wherein in step c) dry aquafaba is added in an amount of from 0.15 to 20 wt %, calculated as the weight of its legume protein on the weight of the vegetable oil in the resulting food composition.

21. The process according to claim 10, wherein the part of the starch phase is added in step d) in an amount of from 20 to 50 wt %, based on the weight of the total amount of starch phase.
